(19) United States
(12) Patent Application Publication
(10) Pub. No.: US 2026/0356758 A1
(43) Pub. Date: Nov. 12, 2026

(54) MATERIALS AND METHOD FOR BRINE SLUDGE BASED CONTROLLED LOW STRENGTH MATERIALS

(71) Applicants: SAHARA INTERNATIONAL PETROCHEMICAL COMPANY (SIPCHEM), Dhahran (SA); KING FAHD UNIVERSITY OF PETROLEUM AND MINERALS, Dhahran (SA)

(72) Inventors: Mohammed IBRAHIM, Dhahran (SA); Mohammed MASLEHUDDIN, Dhahran (SA); Sekhar B. MAMILLA, Dhahran (SA); Mohammed Rizwan ALI, Dhahran (SA)

(73) Assignees: SAHARA INTERNATIONAL PETROCHEMICAL COMPANY (SIPCHEM), Dhahran (SA); KING FAHD UNIVERSITY OF PETROLEUM AND MINERALS, Dhahran (SA)

(21) Appl. No.: 19/203,079

(22) Filed: May 8, 2025

(51) Int. Cl. C04B 28/04; C04B 14/06; C04B 14/28; C04B 18/04

(52) U.S. Cl. CPC C04B 28/04; C04B 14/068; C04B 14/28; C04B 18/0418

(57) ABSTRACT

A method of producing a controlled low strength material, including: mixing a coarse aggregate, a fine aggregate, and ordinary Portland cement to form a dry mixture; mixing water and brine sludge to form a wet mixture; and mixing the dry mixture and the wet mixture to form the controlled low strength material, where: a ratio of the coarse aggregate to a sum of the coarse aggregate and the fine aggregate is from about 0.6 to about 1 by mass, the brine sludge and the ordinary Portland cement have a powder content of from about 120 kg/m³ to about 180 kg/m³, and an oxide composition of the brine sludge includes 50-60 wt % CaO, 2-8 wt % MgO, 0.5-2.0 wt % SrO, 0.5-2.0 wt % Fe₂O₃, 0.5-1.0 wt % SiO₂, and 0.1-0.5 wt % SO₃, and has a loss on ignition of 35-45 wt %.

### BACKGROUND

### Field of the Invention

The present disclosure generally relates to controlled low strength materials (CLSMs) and methods of making the same. M ore specifically, the present disclosure also relates to CLSMs formed by substituting ordinary Portland cement (OPC) with brine sludge, and methods of making the same.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The substitution of ordinary Portland cement (OPC) with alternate materials with lower carbon footprint is a main goal of the worldwide concrete industry. The manufacture of OPC generates enormous quantities of carbon dioxide (CO₂), representing about 5-7% of human-made CO₂ emissions. Generally, the manufacture of one ton of OPC releases almost a ton of CO₂ into the atmosphere. With worldwide cement production being about 4.2 billion tons per year, cement manufacturing releases approximately 4 billion tons CO₂ every year.

Additionally, cement is generally the most costly component of concrete. Reducing the amount of cement in concrete would significantly reduce the overall costs of forming concrete.

Several non-structural applications of concrete, including filling construction cavities and blinding concrete under structural members, and generally filling empty spaces such as trenches, holes, and abandoned structures including basements, require the use of low-strength to very low-strength, highly flowable forms of concrete, generally known as controlled low strength materials (CLSMs). As per ACI Committee 229, a CLSM is a self-consolidating and leveling, cementing material used primarily as a backfill and as an alternative to compacted fill. Recently, the use of CLSMs as cost effective, as well as labor- and time-saving alternatives for compacted fills, has grown substantially. In moving toward a worldwide reduction of greenhouse gas emissions generated by the production of cement, several natural and waste materials have been incorporated in concrete as a partial or full replacement of its cement content. These natural and waste materials include fly ash, natural pozzolan, silica fume, ground granulated blast furnace slag (GGBFS), and other industrial wastes. CLSM backfill materials have also been produced using industrial by-products and waste materials, particularly by partially substituting its cement content with fly ash, which is produced during the burning of coal in thermal power plants.

Waste materials, such as fly ash, have been investigated as a partial replacement of OPC in the production of CLSMs. Fly ash has also been investigated as a replacement for the fine aggregates used in CLSMs. Several other materials, such as silica fume, blast furnace slag, natural pozzolan, etc., have also been studied as partial substitutes of the cement content in CLSMs.

There remains a significant need of reducing the amount of cement in CLSM materials, to further help achieve the economic and environmental benefits that can contribute to the circular economy.

### SUMMARY

Some embodiments of the present disclosure relate to a method of producing a controlled low strength material. The method may include: mixing a coarse aggregate, a fine aggregate, and ordinary Portland cement to form a dry mixture; mixing water and brine sludge to form a wet mixture; and mixing the dry mixture and the wet mixture to form the controlled low strength material, where: a ratio of the coarse aggregate to a sum of the coarse aggregate and the fine aggregate is from about 0.6 to about 1 by mass, the brine sludge and the ordinary Portland cement have a powder content of from about 120 kg/m³ to about 180 kg/m³, and an oxide composition of the brine sludge comprises 50-60 wt % CaO, 2-8 wt % MgO, 0.5-2.0 wt % SrO, 0.5-2.0 wt % Fe₂O₃, 0.5-1.0 wt % SiO₂, and 0.1-0.5 wt % SO₃, determined according to ASTM C114, and has a loss on ignition (LOI) of 35-45 wt %, determined according to ASTM C114.

Some embodiments of the present disclosure relate to a controlled low strength material, which may include: a coarse aggregate; a fine aggregate; water; brine sludge; and ordinary Portland cement; where: a ratio of the coarse aggregate to a sum of the coarse aggregate and the fine aggregate is about 0.6 to 1 by mass, the brine sludge and the ordinary Portland cement have a powder content of from about 120 kg/m³ to about 180 kg/m³, and an oxide composition of the brine sludge comprises 50-60 wt % CaO, 2-8 wt % MgO, 0.5-2.0 wt % SrO, 0.5-2.0 wt % Fe₂O₃, 0.5-1.0 wt % SiO₂, and 0.1-0.5 wt % SO₃, determined according to ASTM C114, and has a loss on ignition (LOI) of 35-45 wt %, determined according to ASTM C114.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 shows preparation of a CLSM using a paddle mixer, according to certain embodiments.

FIG. 2 shows a self-consolidating CLSM, according to certain embodiments.

FIG. 3 shows flow properties of developed CLSMs, according to certain embodiments.

FIG. 4 shows CLSM specimens with varying shapes and geometries, prepared with Ordinary Portland Cement and brine sludge, according to certain embodiments.

FIG. 5 shows flow of CLSMs prepared with a powder content of 120 kg/m³, according to certain embodiments.

FIG. 6 shows flow of CLSMs prepared with a powder content of 180 kg/m³, according to certain embodiments.

FIG. 7 shows compressive strength of CLSMs prepared with a powder content of 120 kg/m³, according to certain embodiments.

FIG. 8 shows compressive strength of CLSMs prepared with a powder content of 180 kg/m³, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

As used herein, the term “controlled low strength material,” “CLSM,” and the like, means a self-consolidating, cement-containing concrete material used primarily as a backfill, which is a cost-effective alternative to compacted fill, as defined per A CI Committee 229.

CLSMs are used by the construction industry for a variety of applications, such as filling of conduits and trenches and as blinding concrete. In addition to its cost effectiveness, it is a labor and time-saving alternative to compacted fills. CLSMs are generally produced using ordinary Portland cement.

One common application of CLSMs is as a blinding concrete in construction applications. Blinding concrete is a thin concrete pour used as an unreinforced base layer beneath a pavement, footing, building foundation, or other reinforced concrete layer. The purposes of the blinding concrete include: providing a smooth, level base of reinforcement for the reinforced concrete layer; preventing concrete seepage into the underlying support soil; preventing the underlying support soil from soaking up water and other components from the reinforced concrete layer; and reducing the effects of soil “soft spots” below the reinforced concrete layer. Thus, blinding layers provide an additional level of support and protection, and a level base, for the reinforced concrete layer.

As used herein, the term “excavatable CLSM” is defined as a CLSM having a compressive strength after curing of about 2.1 MPa or less. Excavatable CLSMs can typically be excavated using either hand tools (for compressive strengths up to about 0.5 MPa) or using a backhoe (for compressive strengths up to 2.1 MPa).

As used herein, the term “non-excavatable CLSM is defined as a CLSM having a compressive strength after curing of from about 2.1 MPa to about 8.3 MPa. N on-excavatable CLSMs can typically not be removed using a backhoe and are intended for permanent application.

Brine sludge is an industrial waste material, produced in large volumes by the chlor-alkali industry. It is presently disposed of in fill areas causing environmental issues. Consequently, there is a need to assess the possibility of this waste materials to be used in developing environmentally friendly construction materials, including CLSMs, and at the same time solving the associated problem of its storage and disposal.

As used herein, the term “brine sludge” means an industrial waste product formed in the chlor-alkali process during the production of caustic soda. Brine sludge typically includes multiple components, with main components including calcium carbonate, magnesium hydroxide, and other insoluble salts such as sodium chloride, as well as impurities including silica and clay minerals. Brine sludge has an alkaline pH at least in part due to the presence of N a and Cl in the mixture. At least a part of the alkalinity of brine sludge may come from hydroxide ions. It is usually disposed of in industrial landfills.

Brine sludge is generally a solid by-product which is formed as a precipitate from the coagulation-flocculation process from the treatment of brine solutions in the chlorine industry. In some cases, industrial brine sludge precipitate may be removed from the industrial process in the form of a heavily viscous slurry, which can be dried to form a solid dry brine sludge powder.

Brine sludge may include heavy metals left over from industrial production. These heavy metals, some of which may be toxic, can be removed from brine sludge before use, such as by sorption with aluminum silicate matrices. The composition of brine sludge varies around the world, and it typically contains a large number of components, with barite, brucite, calcite, illite, quarts and halite phases being phases present in some brine sludges. The elemental composition of brine sludge typically includes Ca, Si, Na, Mg, Al, Cl, P, S, Fe, Ti, M n and K. Varying functional groups can be present in brine sludge, including carbonate, oxide, siloxane, and hydroxide. Typical particle sizes of brine sludge are in the range of from 100 nm to 1 mm, such as 100 nm to 100 μm, or 1 μm to 500 μm, or 1 μm to 100 μm, or 1 μm to 30 μm.

In some embodiments, a density of the brine sludge may be from about 50 to about 150 kg/m³. For example, the density of the brine sludge may be about 150, 125, 100, 75, or 50 kg/m³.

An oxide composition of the brine sludge may include 40-70 wt % CaO, 2-6 wt % MgO, 0.5-2 wt % SrO, 0.5-2 wt % Fe₂O₃, 0.5-1.5 wt % SiO₂, and 0-0.5 wt % SO₃, determined according to ASTM C114, and a loss on ignition (LOI) of 35-45 wt %, determined according to ASTM C114. For example, the CaO composition may be about 50-60 wt %, such as about 52 wt %, about 54 wt %, about 56 wt %, or about 58 wt %, such as about 54.11 wt %. The MgO composition may be 3-5 wt %, such as 4-5 wt %, or about 4.59 wt %. The SrO composition may be 1-1.5 wt %, such as 1-1.25 wt %, such as about 1.11 wt %. The Fe₂O₃ composition may be 1-1.5 wt %, such as about 1.1 wt % or about 1.2 wt %. The SiO₂ composition may be 0.75-1.0 wt %, such as 0.8-0.9 wt %, such as about 0.89 wt %. The SO₃ composition may be 0.25-0.3 wt %, such as 0.27-0.3 wt %, such as about 0.29 wt %. The loss on ignition (LOI) may be 36-40%, such as 36-38%, such as about 37.94%.

In some embodiments, the brine sludge may be at least partially crystalline. The brine sludge may comprise one crystalline phase, or may include multiple crystalline phases therein.

The brine sludge may be at least partially crystalline, and may include one or more main crystalline phases such as calcium carbonate in a form of calcite and aragonite, sodium chloride in a form of halite, magnesium hydroxide in a form of brucite, and quartz, determined according to x-ray diffraction (XRD). For example, the brine sludge may have a crystalline calcium carbonate phase of 10-30 wt %, relative to the total weight of the brine sludge, such as 10-20 wt %, such as 15-20 wt %, such as about 18 wt % or about 18.88 wt %. The brine sludge may have a crystalline sodium chloride phase, relative to the total weight of the brine sludge, of 1-30 wt %, such as 1-10 wt %, such as 2-6 wt %. The brine sludge may have a crystalline magnesium hydroxide phase, relative to the total weight of the brine sludge, of 0-30 wt %, such as 1-10 wt %.

The brine sludge may have a total crystalline component of 0-100 wt %, such as 0-50 wt %, or 50-100 wt %, such as 30-50 wt %, 50-70 wt %, 70-90 wt %, or 90-100 wt %, with the remainder being made up on non-crystalline phases, including amorphous phases and/or liquid phases.

Backfilling is a major operation in the construction of industrial facilities, particularly in the oil and gas industry, for pipelines and foundations. Backfilling using imported soil is a tedious operation requiring multiple layers of soil, requiring controlled compactions as per standard regulatory codes and specifications requirements. In some circumstances, it is impractical to backfill and compact the material to the required degree due to, for example, inaccessibility of the area.

Therefore, some embodiments provide a CLSM that can be used as backfill and as an alternative to compacted fills using imported soil. In some embodiments, the CLSM is useful during the construction and operation of industrial facilities, particularly under time pressure. Utility trenches, for example, often require a fast-track completion and the CLSM materials described herein can advantageously reduce the construction time.

Some embodiments of the present disclosure relate to a method of producing a CLSM. The method may include mixing a coarse aggregate, a fine aggregate, and a cement to form a dry mixture.

The mixing is not particularly limited, and ways of mixing concrete are known to the person of ordinary skill in the art. The mixing may be accomplished using a paddle-wheel mixer, a batch mixer, a drum mixer, a tilting-drum mixer, a reversing drum mixer, a continuous mixer, or a twin-shaft mixture. The ingredients may be mixed together in any particular order. For example, the coarse and fine aggregates first may be added to the mixer first, followed by the activated natural pozzolan. Other ingredients, for example water, may be added to the mixing of the alkali activated binder, to the mixing of the coarse aggregate and the fine aggregate, or the mixing of the binder and the aggregates.

The coarse aggregate is not particularly limited, and may include any granular material used in construction, such as crushed rock or other naturally occurring material. Generally, a coarse aggregate may be categorized as having particles larger than a No. 4 sieve, such as larger than 3/16 inches, and less than 2 inches. In some embodiments, the coarse aggregate comprises crushed limestone. In some embodiments, the crushed limestone has a specific gravity of from about 2.4 to about 2.8, such as about 2.5, about 2.6, or about 2.7. The crushed limestone may have a water absorption of from about 1.75% to about 2.25%, such as about 1.8%, about 1.9%, about 2.0%, about 2.1%, or about 2.2%.

The fine aggregate is not particularly limited, and may include sand, small particles of crushed stone, or crushed slag. Generally, a fine aggregate may have particle sizes that are 0.25 inches or smaller. In some embodiments, the fine aggregate can comprise dune sand. The dune sand may have a specific gravity of 2.2-2.8 g/cc, a water absorption of 0.2-1%, and/or a fineness of 1.4-2.2. For example, the dune sand may have a specific gravity of 2.5-2.7 g/cc, such as 2.5-2.6 g/cc, such as about 2.56 g/cc. The dune sand may have a water absorption of 0.25-0.75%, such as 0.5-0.6%, such as about 0.5%. The dune sand may have a fineness modulus of 1.6-1.9, such as 1.8-1.9, such as about 1.84.

In some embodiments, a ratio of the coarse aggregate (CA) to the total aggregate (CA+FA) was from about 0.4 to about 0.8, such as about 0.5, about 0.6, about 0.65, or about 0.7. In some embodiments, the ratio is from about 0.55 to about 0.65, such as about 0.56, about 0.57, about 0.58, about 0.59, about 0.60, about 0.61, about 0.62, about 0.63, or about 0.64.

The cement may be ordinary Portland cement (OPC). Ordinary Portland cement is a common type of cement used in construction. It is a fine powder made from a mixture of limestone and clay or shale, which are heated in a kiln to produce clinker. This clinker is then ground to a fine powder and mixed with a small amount of gypsum to control the setting time. OPC is categorized into different grades based on strength, such as 33, 43, and 53 MPa.

The Portland cement, or ordinary Portland cement, may be a Type 1, 11, 111 or V ASTM construction cement. For example, Type II may be desirable where moderate heat of hydration is required. Type III or high early cement may be desirable when early compressive strength is needed. Type V may be desirable when high sulfate resistance is required. In other embodiments, Type I and/or Type II OPC may be preferable.

The specific grade of ordinary Portland cement used in the particular disclosure is not particularly limited, and may vary according to the specific application.

In some embodiments, the cement may comprise other cementitious components, in addition to or alternatively to ordinary Portland cement, including fly ash, slag, silica fume, gypsum, limestone and/or bentonite.

Any of the oil well type cements of the class “A-H” as listed in the API Spec 10A, (22nd ed., January 1995 or alternatively ISO 10426-1), are suitable. Especially preferred is Portland cement, preferably an API Class A, C, G or H cement.

In some embodiments, the method includes mixing brine sludge and water to form a wet mixture. The mixing of the brine sludge and water is not particularly limited, and can include any of the mixing methods described above. Prior to mixing, the brine sludge may be subjected to a pre-treatment, such as mixing with sulfuric acid, hydrochloric acid, or a mineral acid to lower the pH of the brine sludge, for 2-24 hours. The brine sludge may be subjected to a filter press or a sieve to achieve particle size modification.

The mixture of brine sludge and water is mixed thoroughly for uniform consistency, with addition of water in small amounts, in a suitable container, which can include plastic or wooden molds of varying sizes and shapes that are commercially available in the market.

In some embodiments, the dry mixture and the wet mixture are mixed to form the CLSM. The mixing of the dry and wet mixtures can be performed in suitable containers, including commercially available plastic or wooden molds. The mixing may include a stirrer or wheel grinding mixing machine, and the stirring may be performed for a period of from two minutes to 3 hours. A vibrator may be used for settling of the mixture in the molds and enhancing uniformity and consistency of the CLSM as it is being formed.

During the mixing of the dry mixture and the wet mixture, additional water may be added to ensure good flowability.

In some embodiments, the CLSM is formed by mixing the dry mixture and the wet mixture in a central-mixed concrete plant. In some embodiments, the CLSM is formed by continuously mixing the ingredients in a vehicle, such as in a truck mixer included in a concrete truck, and is transported as a liquid in its final location, where it can be deposited into an exposed area and self-level horizontally, prior to curing to form the solid form of the CLSM. In some embodiments, the CLSM is formed on site, such as in a pugmill or volumetric mobile concrete mixer. In some embodiments, the CLSM is formed off-site and delivered by conveyed transport by pumping through one or more pipes.

The CLSM is generally cured in situ after depositing in its final destination. In some embodiments, the curing can be accomplished in under 1 hour, under 2 hours, under 3 hours, under 5 hours, 6 hours, under 8 hours, under 12 hours, or under 24 hours.

In some embodiments, the cure time of the CLSM is enhanced by using a curing accelerator. The curing accelerator may have a content of from 1 wt % to 5 wt % relative to the total powder content. The curing accelerator may include calcium chloride (CaCl), silica fume, or finely divided silica gel.

In some embodiments, the CLSM includes fly ash or a pozzolanic material to enhance flowability. W hen fly ash or pozzolanic material is used, an alkaline solution comprising sodium hydroxide (NaOH) and sodium silicate (Na₂SiO₃), or comprising from 1 wt % to 5 wt % sodium sulfate (Na₂SO₄) may also be added to reduce the curing time. In some embodiments, the CLSM does not include fly ash. In some embodiments, the CLSM has sufficient air entrainment to guarantee suitable flow, such as air entrainment of from 15-20% by mass, without using fly ash in the CLSM.

In some embodiments, the CLSM includes additional components selected from spent foundry sand, wood ash, bottom ash, cement kiln dust, and scrap tire rubber.

A powder content can be defined as the sum of the brine sludge content and the OPC content in the CLSM. In some embodiments, the CLSM has a powder content of from about 100 kg/m³ to about 200 kg/m³. For example, the powder content may be about 110 kg/m³, about 120 kg/m³, about 130 kg/m³, about 140 kg/m³, about 150 kg/m³, about 160 kg/m³, about 170 kg/m³, about 180 kg/m³, about 190 kg/m³, or about 200 kg/m³. Powder contents in this range provide for good consistency and compressive strength while simultaneously having good flowability, without bleeding of the CLSM.

In some embodiments, the brine sludge may comprise particles having a spherical morphology. The average diameter of the particles having a spherical morphology may be from about 1 μm to about 100 μm, such as about 10 μm, about 25 μm, about 50 μm, about 75 μm, or about 100 μm. In some embodiments, the average diameter may be even smaller, such as on the order of about 100 nm. The brine sludge may be pre-treated for particle size enhancement, such as reducing the pH of the brine sludge to from 5.0 to 12.0 to make the brine sludge more amenable for a concrete mix. The brine sludge may also be sifted through a sieve to select for a certain particle size distribution, such as a diameter of the particles having a spherical morphology.

In some embodiments, a content of the brine sludge in the CLSM may be from about 10 wt % to about 60 wt % of the content of the OPC in the CLSM material. For example, the brine sludge content may 10-20 wt % of the OPC content, or 20-30 wt %, or 30-40 wt %, or 40-50 wt %, or 50-60 wt %.

In some embodiments, a ratio of the water to the powder content in the CLSM is about 2.1 or less, for example about 2.0 or less, 1.8 or less, 1.6 or less, 1.4 or less, 1.2 or less, or 1.0 or less.

In some embodiments, the CLSM is a concrete comprising a mixture of aggregates or fillers, water, and cementitious material, which is used as a fill or backfill in lieu of compacted earth. In some embodiments, the CLSM is capable of filling all voids in irregular excavations and hard to reach places, including beneath undercuts of existing slabs, voids under pavements, sidewalks, bridges, and other structures, including where natural soil and non-cohesive granular fill has eroded away. The CLSM may be self-leveling, and may harden in a few hours without the need for compaction in layers. In some embodiments, the CLSM may harden in one hour, in two hours, in three hours, in four hours, in five hours, in six hours, in eight hours, in twelve hours, or in 24 hours.

In some embodiments, the CLSM has a compressive strength of at most 8.3 MPa or 1200 psi, such as at most 8 MPa, or at most 7.5 MPa, at most 7 MPa, at most 6 MPa, at most 5 MPa, or at most 4 MPa. In some embodiments, the CLSM compressive strength is measured at less than 3 days after forming the CLSM by mixing the wet mixture and the dry mixture, or measured at less than 5 days, 10 days, 14 days, 21 days, 30 days, 60 days, or 90 days after forming the CLSM.

In some embodiments, the CLSM has a compressive strength of about 2.1 MPa or 300 psi, which is advantageous for future excavation.

In some embodiments, the CLSM is an excavatable CLSM, having a compressive strength of at most 2.1 MPa, such as at most 2 MPa, at most 1.8 MPa, at most 1.6 MPa, at most 1.4 MPa, at most 1.2 MPa, or at most 1.0 MPa.

In some embodiments, the CLSM is a non-excavatable CLSM, having a compressive strength of from 2.1 MPa to 8.3 MPa, such as from 2.1 MPa to 3 MPa, 3 MPa to 4 MPa, 4 MPa to 5 MPa, 5 MPa to 6 MPa, 6 MPa to 7 MPa, or 7 MPa to 8.3 MPa.

In some embodiments, the CLSM has a flow of 200 mm or more, such as 205 mm or more, 210 mm or more, 215 mm or more, 220 mm or more, 225 mm or more, or 230 mm or more.

In some embodiments, the CLSM has a unit weight of 2250 kg/m³ or less, such as 2200 kg/m³ or less, 2150 kg/m³ or less, 2100 kg/m³ or less, or 2090 kg/m³ or less.

In some embodiments, the CLSMs used herein can be advantageously used for backfilling utility trenches, filling abandoned underground structures, backfilling bridge abutments and retaining walls, structural fills, insulating and isolation fills, thermal-insulation-conductivity fills, pavement bases, conduit bedding, utility trenches, road subgrade, erosion control and in nuclear facilities.

The benefits of the CLSMs described herein for these applications, compared to conventional earth fill materials that require controlled compaction of the soil in layers, include: ease of mixing and placement of the CLSM material, ability to place the CLSM material into confined spaces, self-leveling characteristics, rapid curing, incompressibility after curing, reduction of equipment needs, and reduction in labor costs and associated inspections.

In some embodiments, the CLSM is a brine sludge based CLSM that is suitable for use in industrial applications, such as backfilling, filling construction cavities, and blinding concrete. The ordinary Portland Cement conventionally used in CL SM s may have been partially replaced with brine sludge, to produce CLSMs of high quality for industrial applications. Particular advantages of the CLSMs described herein include: effective utilization of industrial waste material, environmental protection, and minimizing the use of costly OPC.

The brine-sludge based CLSMs of some embodiments were tested to assess their fresh and hardened properties. Viable excavatable CLSMs and non-excavatable CLSMs were produced by replacing significant quantity of cement with brine sludge. The CLSMs possess improved fresh and hardened properties and they can be used as backfilling materials, filling abandoned underground structures and backfilling bridge abutments and retaining walls, structural fills, and insulating and isolation fills.

In some embodiments, two categories of CLSMs are provided: one especially suitable for excavatable applications, and one especially suitable for non-excavatable applications. In some embodiment, the excavatable CLSMs have about 45 wt % of OPC replaced with brine sludge on a mass basis, such as about 30 wt %, about 35 wt %, about 40 wt %, about 45 wt %, about 50 wt %, about 55 wt %, or about 60 wt %. In some embodiments, the non-excavatable CL SM s have about 20 wt % of OPC replaced with brine sludge on a mass basis, such as about 10 wt %, about 15 wt %, about 20 wt %, about 25 wt %, or about 30 wt %.

The CLSMs of some embodiments satisfy the flow, segregation, bleeding, and setting time requirements specified in international standards. For example, the unconfined compressive strength of excavatable CLSMs of some embodiments was less than 2.1 MPa, while the unconfined compressive strength of non-excavatable CLSMs of some embodiments was from 2.0 MPa to 8.0 MPa.

### EXAMPLES

### Example 1: Trial Mixtures of CLSMs Using Ordinary Portland Cement

### Materials

In some embodiments, the CLSMs described herein were produced using dune sand with a specific gravity, fineness modulus and water absorption of 2.55 g/cc, 1.85, and 0.51%, respectively, as fine aggregate (FA). In some embodiments, the CLSMs described herein were produced using crushed limestone having a specific gravity of 2.61 and water absorption of 1.95% was used as coarse aggregate (CA).

Table 1 shows the oxide composition of brine sludge according to some embodiments of the present disclosure.

TABLE 1
Oxide composition of brine sludge and loss on ignition (LOI).

| Oxides | Weight, % |
|---|---|
| CaO | 54.11 |
| MgO | 4.59 |
| SrO | 1.11 |
| Fe₂O₃ | 1.07 |
| SiO₂ | 0.89 |
| SO₃ | 0.29 |
| LOI | 37.94 |

### Methods

Trials were conducted by varying aggregate proportions, water to powder (ordinary Portland cement plus brine sludge) ratio, and powder content, to produce CLSMs possessing desired fresh properties, including flow properties. Table 2 shows the proportions of materials used in the trial CLSMs prepared with OPC.

TABLE 2
Proportions of materials used in trial CLSMs prepared with OPC.

| | Total | | | | | | | | |
|---|---|---|---|---|---|---|---|---|---|
| Mix | powder, | OPC, | BS | W/C, | CA/TA, | FA/TA, | CA, | FA, | Water, |
| # | kg/m³ | kg/m³ | kg/m³ | ratio | ratio | ratio | kg/m³ | kg/m³ | kg/m³ |
| TM1 | 100 | 100 | 0 | 1.75 | 0.3 | 0.7 | 612 | 1428 | 195 |
| TM2 | 120 | 120 | 0 | 1.75 | 0.3 | 0.7 | 580 | 1354 | 229 |
| TM3 | 120 | 120 | 0 | 1.8 | 0.35 | 0.65 | 672 | 1248 | 236 |
| TM4 | 120 | 120 | 0 | 2.0 | 0.4 | 0.6 | 743 | 1116 | 261 |
| TM5 | 120 | 120 | 0 | 2.2 | 0.4 | 0.6 | 719 | 1078 | 284 |
| TM6 | 120 | 120 | 0 | 2.4 | 0.4 | 0.6 | 694 | 1041 | 308 |

In Table 2, the term “total powder” refers to the quantity of “cement+brine sludge.”

Subsequently, two batches of CLSMs were prepared by partially replacing OPC with brine sludge, one with low powder content and the other with moderate powder content, named Group A and Group B, respectively.

The first batch with low powder content was suitable for use as an excavatable CLSM that required an unconfined compressive strength of ≤2.1 MPa (300 psi). The other batch, with a moderate powder content and a compressive strength of up to 8.3 MPa (1200 psi), was suitable for use as a non-excavatable CLSM.

### Example 2: CLSMs with Brine Sludge Replacing a Portion of the Ordinary Portland Cement

Tables 3 and Table 4 show the relative proportions of materials divided into two groups: Group A (corresponding to an excavatable CLSM) and Group B (corresponding to a —excavatable CLSM), respectively.

TABLE 3
Mix proportions in excavatable CLSM prepared
with brine sludge (BS) and OPC.

| | | | | | Coarse | Fine | |
|---|---|---|---|---|---|---|---|
| | Total | | | | aggre- | aggre- | |
| Mix | powder, | OPC, | BS, | W/C, | gate, | gate, | Water, |
| # | kg/m³ | kg/m³ | kg/m³ | ratio | kg/m³ | kg/m³ | kg/m³ |
| A0 | 120 | 120 | 0 | 2.25 | 712 | 1069 | 290 |
| A15 | 120 | 102 | 18 | 2.10 | 705 | 1058 | 280 |
| A30 | 120 | 84 | 36 | 1.90 | 706 | 1060 | 262 |
| A45 | 120 | 66 | 54 | 1.70 | 711 | 1067 | 241 |

TABLE 4
Mix proportions in non-excavatable CLSM prepared with BS.

| | | | | | Coarse | Fine | |
|---|---|---|---|---|---|---|---|
| | Total | | | | aggre- | aggre- | |
| Mix | powder, | OPC, | BS, | W/C, | gate, | gate, | Water, |
| # | kg/m³ | kg/m³ | kg/m³ | ratio | kg/m³ | kg/m³ | kg/m³ |
| B0 | 180 | 180 | 0 | 1.35 | 721 | 1081 | 263 |
| B10 | 180 | 162 | 18 | 1.30 | 710 | 1065 | 256 |
| B15 | 180 | 153 | 27 | 1.28 | 704 | 1056 | 254 |
| B20 | 180 | 144 | 36 | 1.25 | 700 | 1051 | 249 |

For preparing the concrete specimens, the required quantities of coarse aggregate (crushed limestone), fine aggregate (dune sand), and OPC were measured and placed in a paddle mixer and thoroughly mixed prior to the addition of the liquid portion of the mixture.

In the mixtures where brine sludge was to be used, the brine sludge was mixed with the required quantity of water thoroughly, and it was added to the other mixture constituents.

Subsequently, wet mixing was carried out for at least three minutes to ensure the homogeneity of the mixture, after which the concrete was poured in the molds in two layers.

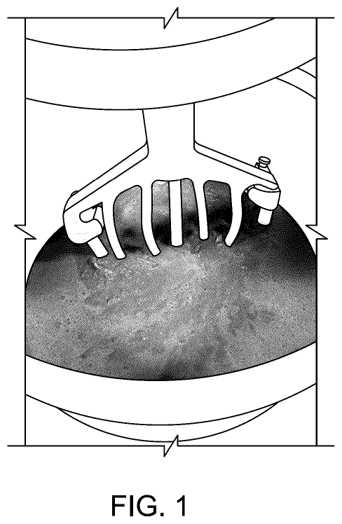

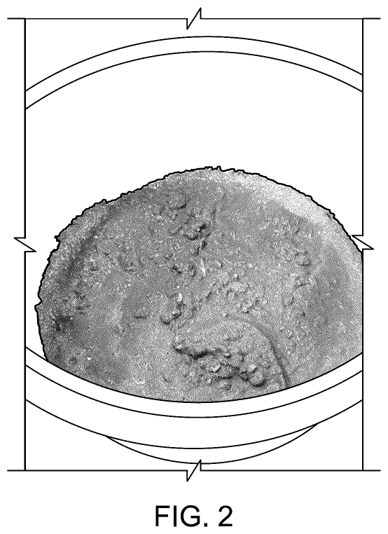

FIG. 1 shows a CLSM sample being mixed in a paddle mixer, while FIG. 2 shows the CLSM sample after mixing. All the CLSM mixtures were highly flowable; consequently, vibration was not required for consolidation.

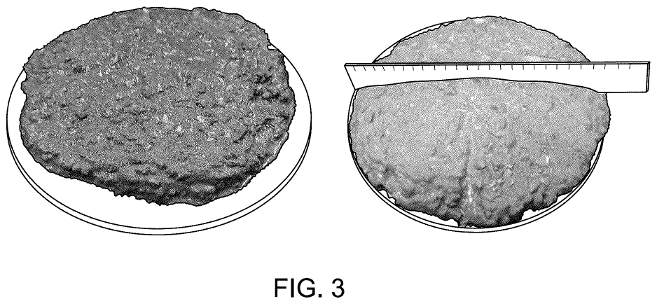

FIG. 3 illustrates the spread diameter of CLSM on a flow table. After placing the CLSM into the molds, the surface was levelled with a trowel. After placement and finishing, the specimens were covered with a plastic sheet to prevent loss of moisture, and the molds were kept under laboratory conditions for 24 hours prior to demolding.

Immediately after demolding, the weight and dimensions of each specimen were noted to determine the unit weight. FIG. 4 shows concrete specimens of varying shape and geometry prepared with the CLSM.

The workability of successfully prepared CLSMs was assessed by measuring the flow in accordance with the procedure outlined in ASTM D6103. ASTM D6103 (2016). Standard Test Method for Flow Consistency of Controlled Low Strength Material, Annual Book of ASTM Standards, American Society for Testing and Materials, West Conshohocken, PA (the contents of which are incorporated by reference herein in their entirety).

The unit weight was measured according to ASTM D6023. ASTM D6023 (2016). Standard Test Method for Density (Unit Weight), Yield, Cement Content, and Air Content (Gravimetric) of Controlled Low-Strength Material (CLSM), Annual Book of ASTM Standards, American Society for Testing and Materials, West Conshohocken, PA (the contents of which are incorporated by reference herein in their entirety).

The compressive strength of the developed CLSMs was determined on 50 mm cube specimens after 1, 3, 7, and 28 days of curing, following the procedures outlined in ASTM C109. ASTM C109 (2016). Standard Test Method for Compressive Strength of Hydraulic Cement Mortars (Using 2-in. or [50-mm] Cube Specimens), Annual Book of ASTM Standards, American Society for Testing and Materials, West Conshohocken, PA (the contents of which are incorporated by reference herein in their entirety).

The water absorption of hardened CLSM was evaluated following the procedures outlined in ASTM C642. ASTM C642 (2016). Standard Test Method for Density, Absorption, and Voids in Hardened Concrete, Annual Book of ASTM Standards, American Society for Testing and Materials, West Conshohocken, PA (the contents of which are incorporated by reference herein in their entirety).

### Workability

Table 5 shows the flow of trial CLSMs. Some of the trial mixtures were stiff with insufficient flow. The spread diameter was less than 200 mm in mixtures TM 1 to TM 5. However, the spread diameter of Mix TM 6 was more than 200 mm, which is the requirement for a material to be classified as CLSM. This mixture was prepared with a water to powder ratio of 2.4. However, marginal bleeding was observed in this particular mixture.

Consequently, the composition of Mix TM 6 was selected with minor changes to prepare two batches of CLSMs with a total powder content of 120 kg/m³ and 180 kg/m³, respectively. In these two mixtures, the OPC was partially replaced with brine sludge.

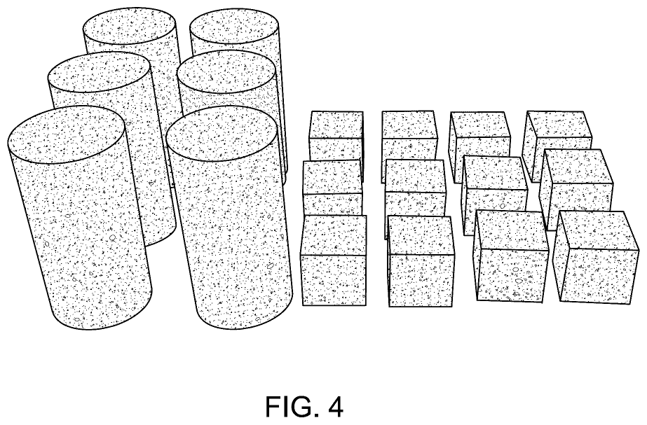

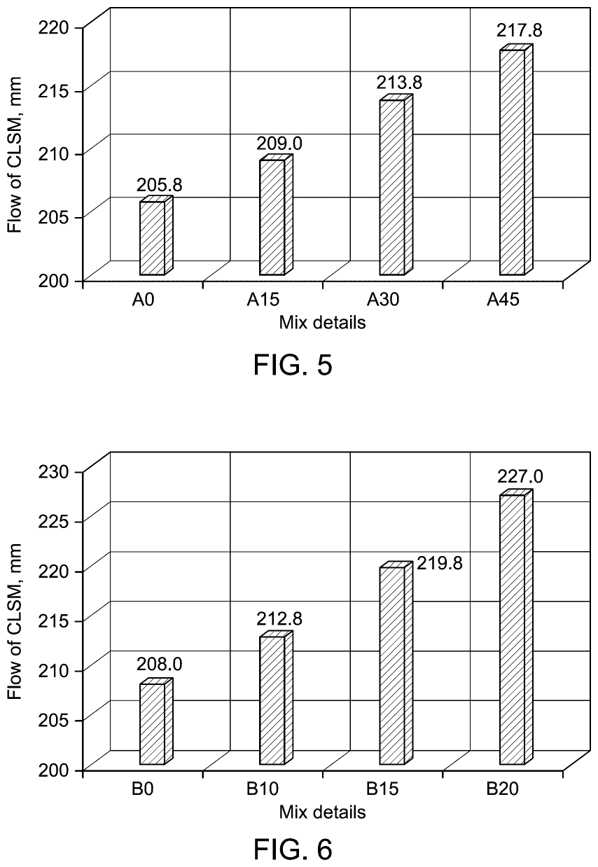

FIG. 5 and FIG. 6 depict the flow of CLSM mixtures prepared with powder contents of 120 kg/m³ and 180 kg/m³, respectively. In the first batch, prepared with a powder content of 120 kg/m³, 15% to 45% of the OPC was replaced with brine sludge. The flow in these mixtures was between 205 and 218 mm. In the second batch, prepared with a powder content of 180 kg/m³, 10 to 20% BS was incorporated, which resulted in flows ranging from 208 to 227 mm.

In both groups of mixtures, increasing the quantity of brine sludge decreased the amount of water required to produce the required flow. A flow of 200 mm is required to be able to classify the CLSM mix as suitable for general purpose applications. Increasing the quantity of brine sludge in the CLSMs increased the flowability and homogeneity, which may be attributed to the spherical morphology of some of the particles in brine sludge.

TABLE 5
Flow of CLSM trial mixtures.

| | Flow, mm | | | | | |
|---|---|---|---|---|---|---|
| Mix # | 1 | 2 | 3 | 4 | Average | Remarks |
| TM1 | 118 | 121 | 129 | 125 | 123 | Stiff and not flowable |
| TM2 | 135 | 131 | 129 | 130 | 131 | Stiff and not flowable |
| TM3 | 148 | 158 | 159 | 153 | 155 | Stiff and not flowable |
| TM4 | 175 | 179 | 188 | 185 | 182 | Good flow and not |
| | | | | | | qualified as CLSM |
| TM5 | 189 | 200 | 193 | 197 | 195 | Good flow and not |
| | | | | | | qualified as CLSM |
| TM6 | 211 | 209 | 218 | 215 | 213 | Good flow and |
| | | | | | | qualified as CLSM, |
| | | | | | | however, noted to have |
| | | | | | | marginal bleeding |

### Unit Weight

Table 6 and Table 7 show the unit weight of CLSMs prepared with a powder content of 120 and a powder content of 180 kg/m³, respectively. The unit weight of control mixtures A0 and B0, prepared without BS, was 2123 and 2233 kg/m³, respectively. In general, the unit weight of CLSMs decreased with increasing quantity of BS. The unit weight varied between 2094 and 2076 kg/m³ in the first batch of CLSMs with a total powder content of 120 kg/m³ while it was in the range of 2247 to 2192 kg/m³ in the second batch of CLSMs (180 kg/m³). The lowest unit weight was noted in the mixture incorporating 45% BS. Generally, a higher powder content produced a dense CLSM.

TABLE 6
Unit weight of CLSMs prepared with a powder
content of 120 kg/m³ (Group A mixtures).

| | | | | | | | Unit | Average |
|---|---|---|---|---|---|---|---|---|
| Mix | BS, | Specimen | Length, | Width, | Height, | Weight, | weight, | unit weight, |
| # | % | # | mm | mm | mm | g | kg/m³ | kg/m³ |
| A0 | 0 | 1 | 51.25 | 50.13 | 52.19 | 282.88 | 2110 | 2123 |
| | | 2 | 50.16 | 50.15 | 53.17 | 284.97 | 2131 | |
| | | 3 | 49.50 | 50.13 | 52.80 | 278.82 | 2128 | |
| A15 | 15 | 1 | 50.62 | 49.79 | 51.95 | 275.06 | 2101 | 2094 |
| | | 2 | 51.38 | 50.32 | 52.40 | 283.96 | 2096 | |
| | | 3 | 51.40 | 49.96 | 52.13 | 279.02 | 2084 | |
| A30 | 30 | 1 | 50.10 | 49.69 | 52.70 | 275.49 | 2100 | 2081 |
| | | 2 | 50.04 | 49.25 | 52.52 | 269.92 | 2085 | |
| | | 3 | 50.37 | 51.21 | 54.42 | 289.03 | 2059 | |
| A45 | 45 | 1 | 50.55 | 49.90 | 52.06 | 274.08 | 2087 | 2076 |
| | | 2 | 50.86 | 50.09 | 51.90 | 274.72 | 2078 | |
| | | 3 | 50.00 | 51.34 | 52.24 | 276.81 | 2064 | |

TABLE 7
Unit weight of CLSMs prepared with a powder
content of 180 kg/m³ (Group B mixtures).

| | | | | | | | Unit | Average |
|---|---|---|---|---|---|---|---|---|
| Mix | BS, | Specimen | Length, | Width, | Height, | Weight, | weight, | unit weight, |
| # | % | # | mm | mm | mm | g | kg/m³ | kg/m³ |
| B0 | 0 | 1 | 48.98 | 50.80 | 52.97 | 288.26 | 2187 | 2233 |
| | | 2 | 51.22 | 50.82 | 52.07 | 295.92 | 2183 | |
| | | 3 | 49.25 | 48.61 | 52.28 | 291.56 | 2329 | |
| B10 | 10 | 4 | 49.20 | 51.74 | 51.98 | 299.42 | 2263 | 2247 |
| | | 5 | 51.93 | 51.45 | 50.07 | 301.42 | 2253 | |
| | | 6 | 51.46 | 51.85 | 50.98 | 302.65 | 2225 | |
| B15 | 15 | 7 | 48.95 | 51.97 | 53.98 | 306.3 | 2231 | 2214 |
| | | 8 | 49.44 | 50.96 | 53.12 | 298.44 | 2230 | |
| | | 9 | 50.05 | 49.98 | 52.88 | 288.63 | 2182 | |
| B20 | 20 | 10 | 50.58 | 49.88 | 52.18 | 297.35 | 2259 | 2192 |
| | | 11 | 50.48 | 49.27 | 53.88 | 291 | 2172 | |
| | | 12 | 50.32 | 53.24 | 51.00 | 293.14 | 2145 | |

### Compressive Strength

Table 8 shows the compressive strength development in the CLSM trial mixtures. The trial mixtures TM 1 to TM 6, were prepared without brine sludge in order to optimize the mixture composition to have the desired flow properties. The compressive strength of Mixture TM 1 prepared with 100 kg/m³ of cement was 1.59 MPa after seven days. In order to improve the strength and workability of CLSM, the powder content was increased to 120 kg/m³.

Subsequently, to improve the fresh properties, the w/c ratio, CA/TA and FA/TA ratios were varied to optimize the composition of CLSMs. The CLSM with a lower water to powder ratio resulted in a higher compressive strength; however, it could not qualify as a general purpose CLSM due to the lower flow. The 7-day compressive strength and spread diameter of Mixture TM 6 prepared with a w/c ratio of 2.4 was 2.69 MPa and 200 mm, respectively.

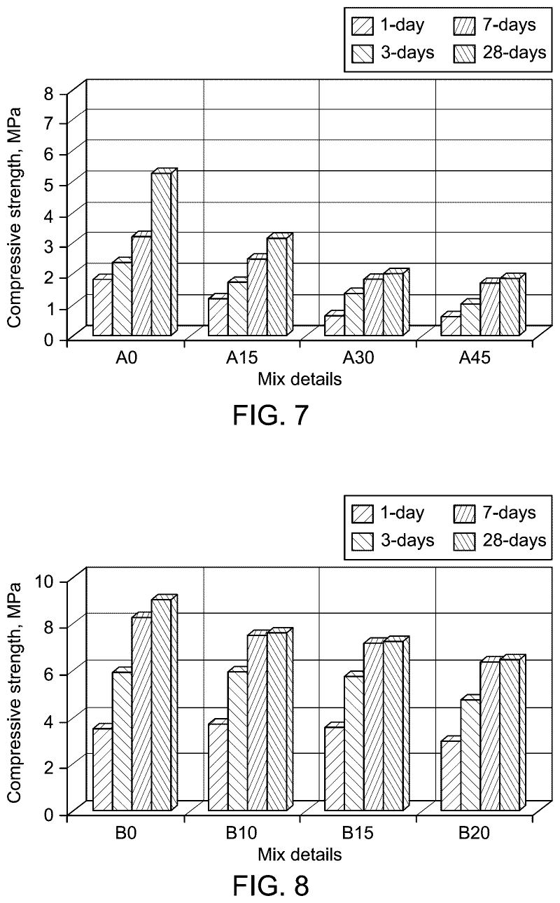

FIG. 7 and FIG. 8 show the compressive strength development of Group A and Group B B CLSMs, as listed in Tables 7 and 8, respectively. After seven days of curing, the compressive strength of control mix in Group A, prepared with a total powder content of 120 kg/m³, was 3.17 MPa. The compressive strength of mixtures prepared with 15%, 30%, and 45% brine sludge was 2.47, 1.81 and 1.67 MPa, respectively. Further, the data in FIGS. 7 and 8 show a proportional decrease in the compressive strength with increasing quantity of brine sludge. After 28 days of curing, the compressive strength of mixtures A0, A15, A30, and A45 was 5.24, 3.15, 2.00 and 1.83 MPa, respectively. A s the compressive strength of mixtures A0 and A15 was more than 2.1 MPa, they are suitable for non-excavatable applications, such as blinding concrete, filling cavities and non-structural applications, while mixtures A30 and A45 are suitable for excavatable applications. The compressive strength of CLSMs B0, B10, B15, and B20 was 8.99, 7.57, 7.20, and 6.41 MPa, respectively, after 28 days of curing; therefore, these mixtures are suitable for non-excavatable applications.

TABLE 8
Compressive strength of trial CLSMs.

| | Compressive strength, MPa | | |
|---|---|---|---|
| Mix # | 1-day | 3-days | 7-days |
| TM1 | 0.62 | 0.92 | 1.59 |
| TM2 | 1.35 | 2.25 | 3.82 |
| TM3 | 1.29 | 2.17 | 3.54 |
| TM4 | 1.25 | 2.01 | 3.33 |
| TM5 | 1.18 | 1.86 | 2.79 |
| TM6 | 0.98 | 1.73 | 2.69 |

The following conclusions can be drawn from the above results. Substantial quantity of OPC can be replaced with BS in the preparation of CLSMs. The incorporation of BS significantly enhanced the flow and homogeneity of the CL SM s. Bleeding and segregation were also minimized due to the incorporation of BS in the CLSMs. The water demand decreased with an increase in the quantity of BS due to their spherical morphology. U p to 45% and 20% OPC can be substituted by BS for producing excavatable and non-excavatable CL SM s, respectively.

Some of the advantages of the brine-sludge based CLSM S described herein include the following. Brine sludge, an industrial waste material, can comprise a significant portion of the powder content in CLSM S, forming an effective substitute for OPC. The developed CLSMs are environmentally friendly, since they replace ordinary Portland cement whose production is energy intensive and generates significant greenhouse gases, particularly carbon dioxide. The CLSMs described herein provide cost effective and time saving alternatives to backfilling. The CLSMs are suitable for numerous applications, including backfilling, filling abandoned underground structures and backfilling bridge abutments and retaining walls, structural fills, and insulating and isolation fills.

Numerous modifications and variations of the present disclosure are possible in light of the above teachings. It is therefore to be understood that within the scope of the appended claims, the invention may be practiced otherwise than as specifically described herein.

1. A method of producing a controlled low strength material, the method comprising:
mixing a coarse aggregate, a fine aggregate, and ordinary Portland cement to form a dry mixture;
mixing water and brine sludge to form a wet mixture; and
mixing the dry mixture and the wet mixture to form the controlled low strength material,
wherein:
a ratio of the coarse aggregate to a sum of the coarse aggregate and the fine aggregate is from about 0.6 to about 1 by mass,
the brine sludge and the ordinary Portland cement have a powder content of from about 120 kg/m³ to about 180 kg/m³, and
an oxide composition of the brine sludge comprises 50-60 wt % CaO, 2-8 wt % MgO, 0.5-2.0 wt % SrO, 0.5-2.0 wt % Fe₂O₃, 0.5-1.0 wt % SiO₂, and 0.1-0.5 wt % SO₃, determined according to ASTM C114, and has a loss on ignition (LOI) of 35-45 wt %, determined according to ASTM C114.

2. The method of claim 1, wherein the coarse aggregate comprises crushed limestone having a specific gravity of 2.5 g/cc to 2.7 g/cc and a water absorption of 1.75% to 2.25%.

3. The method of claim 1, wherein the fine aggregate comprises dune sand having a specific gravity of 2.25 g/cc to 2.75 g/cc, a fineness modulus of 1.8 to 1.9, and a water absorption of 0.25% to 1.0%.

4. The method of claim 1, wherein the brine sludge comprises particles having a spherical morphology.

5. The method of claim 1, wherein an amount of the brine sludge is from 15% to 45% of an amount of the ordinary Portland cement.

6. The method of claim 1, wherein the controlled low strength material has a flow of 200 mm or more.

7. The method of claim 1, wherein the powder content of the brine sludge and the ordinary Portland cement is about 120 kg/m³.

8. The method of claim 7, wherein a ratio of the water to the powder content is 2.1 to 1 by mass or less.

9. The method of claim 7, wherein the controlled low strength material has a compressive strength of 2.1 MPa or less.

10. The method of claim 7, wherein an average unit weight of the controlled low strength material is 2100 kg/m³ or less.

11. The method of claim 1, wherein the powder content of the brine sludge and the ordinary Portland cement is about 180 kg/m³.

12. The method of claim 11, wherein a ratio of the water to the powder content is 1.4 to 1 by mass or less.

13. The method of claim 11, wherein the controlled low strength material has a compressive strength of from 2.1 MPa to 8.3 MPa.

14. The method of claim 11, further comprising:
dispensing, self-consolidating, and leveling the controlled low strength material to form an unreinforced base layer in an excavation; and
forming a reinforced concrete layer on the unreinforced base layer using a different curable material from the controlled low strength material,
wherein an average unit weight of the controlled low strength material is about 2250 kg/m³ or less.

15. A controlled low strength material, comprising:
a coarse aggregate;
a fine aggregate;
water;
brine sludge; and
ordinary Portland cement;
wherein:
a ratio of the coarse aggregate to a sum of the coarse aggregate and the fine aggregate is about 0.6 to 1 by mass,
the brine sludge and the ordinary Portland cement have a powder content of from about 120 kg/m³ to about 180 kg/m³, and
an oxide composition of the brine sludge comprises 50-60 wt % CaO, 2-8 wt % MgO, 0.5-2.0 wt % SrO, 0.5-2.0 wt % Fe₂O₃, 0.5-1.0 wt % SiO₂, and 0.1-0.5 wt % SO₃, determined according to ASTM C114, and has a loss on ignition (LOI) of 35-45 wt %, determined according to ASTM C114.

16. The controlled low strength material of claim 15, wherein the brine sludge comprises particles having a spherical morphology.

17. The controlled low strength material of claim 15, wherein an amount of the brine sludge is from 15% to 45% of the amount of the ordinary Portland cement.

18. The controlled low strength material of claim 15, wherein the controlled low strength material has a flow of 200 mm or more.

19. The controlled low strength material of claim 15, wherein the powder content of the brine sludge and the ordinary Portland cement is about 120 kg/m³, a ratio of the water to the powder content is 2.1 to 1 by mass or less, and the controlled low strength material has a flow of 200 mm or more and a compressive strength of about 2.1 MPa or less.

20. The controlled low strength material of claim 15, wherein the powder content of the brine sludge and the ordinary Portland cement is about 180 kg/m3, a ratio of the water to the powder content is 1.4 to 1 by mass or less, and the controlled low strength material has a flow of 200 mm or more and a compressive strength of from about 2.1 MPa to about 8.3 MPa.
